(19) United States
(12) Patent Application Publication
(10) Pub. No.: US 2025/0377561 A1
(43) Pub. Date: Dec. 11, 2025

(54) Optical Modulator

(71) Applicant: Nippon Telegraph and Telephone Corporation, Tokyo (JP)

(72) Inventors: Ken Tsuzuki, Musashino-shi, Tokyo (JP); Makoto Jizodo (deceased), Musashino-shi, Tokyo (JP)

(21) Appl. No.: 18/872,012

(22) PCT Filed: Jun. 10, 2022
(86) PCT No.: PCT/JP2022/023525

§ 371 Date: Dec. 5, 2024

(51) Int. Cl. G02F 1/025; G02F 1/225

(52) U.S. Cl. CPC G02F 1/025; G02F 1/2255

(57) ABSTRACT

With a structure in which an ion implantation pattern can be controlled with a wider range of options, optical modulation efficiency is enhanced. An optical modulator including a semiconductor layer with a pn junction in an optical waveguide core. The optical modulator includes: a low-concentration p-type semiconductor layer and a low-concentration n-type semiconductor layer that form the pn junction; and a medium-concentration p-type semiconductor layer that is added to the low-concentration p-type semiconductor layer or a medium-concentration n-type semiconductor layer that is added to the low-concentration n-type semiconductor layer. The optical waveguide core configured with three layers of the low-concentration p-type semiconductor layer, the medium-concentration p-type semiconductor layer, and the low-concentration n-type semiconductor layer, or configured with three layers of the low-concentration p-type semiconductor layer, the medium-concentration n-type semiconductor layer, and the low-concentration n-type semiconductor layer.

### TECHNICAL FIELD

The present invention relates to an optical modulator, and more particularly to an optical modulator that is used in an optical communication system, an optical information processing system, and the like, performs an optical modulation operation at a high speed, has excellent frequency characteristics and waveform quality, and can perform optical communication over a long distance.

### BACKGROUND ART

Due to the spread of high-definition video distribution services and mobile communication, the amount of traffic flowing through a network has become enormous and has been increasing year by year. In order to construct a high-speed and large-capacity optical network capable of meeting such traffic demands, development of a basic device capable of high-speed operation used in each node has been energetically performed. An optical modulator that directly modulates an optical signal with a broadband baseband signal is one of important devices.

A Mach-Zehnder (MZ) type optical modulator has a structure in which light incident on an optical waveguide is split into two waveguides at an intensity of 1:1, and the pieces of split light are caused to propagate for a certain length and then are multiplexed again. In the MZ type optical modulator, phases of the two pieces of split light are changed by phase modulation portions provided in the two split optical waveguides. The intensity and the phase of the light can be modulated by changing the interference condition of the light when the two pieces of light subjected to the phase change are multiplexed.

As a material constituting the optical waveguides of the MZ type optical modulator, a dielectric such as LiNbO₃, or a semiconductor such as InP, GaAs, or Si is used. By inputting a modulation electrical signal to an electrode disposed in the vicinity of the optical waveguide made of the material described above and applying a modulation voltage to the optical waveguide, the phase of light propagating through the optical waveguide is changed.

As a mechanism for changing the phase of light in the MZ type optical modulator, the Pockels effect is used when the material is LiNbO₃. When the material is InP or GaAs, the Pockels effect and the quantum-confined Stark effect (QCSE) are used, and when the material is Si, the carrier plasma effect is mainly used.

In order to perform high-speed and low-power-consumption optical communication, an optical modulator with a high modulation speed and a low drive voltage is required. Specifically, it is required to perform optical modulation at a high speed of 10 Gbps or more and with an amplitude voltage of several volts. In order to achieve this, a traveling-wave electrode is required that matches the speed of a high-speed electrical signal and the speed of light propagating through a phase modulator, and allows the light and electrical signal to interact as they propagate. As an optical modulator using a traveling-wave electrode, for example, as disclosed in Patent Literature 1, an optical modulator with an electrode length of several mm to several tens of mm has been put into practical use.

In an optical modulator using a traveling-wave electrode, an electrode structure and an optical waveguide structure with low loss and less reflection are required so that the propagation can be performed without decreasing the amplitude of the electrical signal and the intensity of light propagating through the waveguide. That is, an electrode structure with less reflection loss and propagation loss over a wide frequency band is required for the electrical signal, and a waveguide structure capable of efficiently confining light with less reflection and propagating the light without loss is required for the light.

As a promising MZ type optical modulator from the viewpoint of a substrate material and a manufacturing process, there is a Si optical modulator in which an optical waveguide is made of Si. The Si optical modulator is manufactured from a silicon on insulator (SOI) substrate in which a thin film of Si is attached onto a buried oxide (BOX) layer obtained by thermally oxidizing the surface of the Si substrate. In the optical waveguide, a Si thin film is processed into a thin line so that light can be guided through the SOI layer, and then impurities are injected so that a p-type semiconductor and an n-type semiconductor can be formed. Finally, SiO₂ to be a cladding layer of light is deposited, formation of an electrode, and the like are formed to manufacture the electrode.

At this time, the waveguide of light needs to be designed and processed so as to reduce the light loss. Specifically, p-type and n-type impurity doping and manufacture of the electrode need to be designed and processed so as to suppress light loss and to suppress reflection loss and propagation loss of a high-speed electrical signal.

FIG. 1 illustrates a cross-sectional structure of an optical waveguide as the basis of a Si optical modulator of a conventional technique. FIG. 1 illustrates a cross-section (x-z plane) of an optical waveguide 200 formed on an SOI substrate, cut perpendicularly to a light traveling direction (y-axis). The light propagates in a direction perpendicular to the paper surface (y-axis direction). The optical waveguide 200 of the Si optical modulator includes a Si layer 2 sandwiched between upper and lower SiO₂ cladding layers 1 and 3. The Si thin line formed at the center of FIG. 1 for confining light has a structure called a rib waveguide with a difference in thickness. That is, as illustrated in FIG. 1, the rib waveguide includes a Si layer 201 that is thick at the central portion and slab regions 202a and 202b that are thin on both sides thereof. The Si layer 201 that is thick at the center of the Si layer 2 is used as an optical waveguide core, and a refractive index difference with respect to the surrounding SiO₂ cladding layers 1 and 3 is used to constitute the optical waveguide 200 that confines light propagating in the direction perpendicular to the paper surface.

In the slab regions 202a and 202b that are thin on both sides of the optical waveguide core (hereinafter, referred to as the Si optical waveguide core 201) of the thick Si layer 201, a high-concentration p-type semiconductor layer 211 and a high-concentration n-type semiconductor layer 214 are provided, respectively. Further, a pn junction structure including a low-concentration p-type semiconductor layer 212 and a low-concentration n-type semiconductor layer 213 is formed in the Si optical waveguide core 201 and the vicinity thereof. As described below, a modulation electrical signal and a bias voltage are applied from both left and right ends of the Si layer 2 in FIG. 1 through electrodes, which are not illustrated. Instead of the pn junction at the central portion of the core, a pin structure may be adopted in which an undoped i-type (intrinsic) semiconductor is sandwiched in the pn junction structure of the low-concentration p-type semiconductor layer 212 and the low-concentration n-type semiconductor layer 213.

The phase modulation operation in the optical waveguide 200 of the Si optical modulator can be described as the following. Although not illustrated in FIG. 1, two metal electrodes in contact with the high-concentration p-type semiconductor layer 211 and the high-concentration n-type semiconductor layer 214 at both ends of the Si layer 2 are provided. A reverse bias voltage is applied to the pn junction portion at the center of the core through the two metal electrodes together with a radio frequency (RF) modulation electrical signal. That is, a voltage with a positive potential on the high-concentration n-type semiconductor layer 214 side and a negative potential on the high-concentration p-type semiconductor layer 211 side is applied from the right end to the left end of the optical waveguide 200 (in the x-axis direction). The reverse bias voltage and the modulation electrical signal change the carrier density inside the thick Si optical waveguide core 201. With changing the carrier density to cause a change in the refractive index of the Si optical waveguide core 201 due to the carrier plasma effect, the phase of light propagating through the optical waveguide can be modulated.

The dimensions of the optical waveguide in the Si optical modulator depend on the refractive index of each material serving as the core/cladding. An example in the case of a rib type silicon waveguide structure with the thick Si optical waveguide core 201 and the slab regions 202a and 202b on both sides thereof as illustrated in FIG. 1 will be listed. The width (x-axis direction) of the Si optical waveguide core 201 is 400 to 600 (nm), the height (z-axis direction) of the core portion is 150 to 300 (nm), the thickness of the slab region is 50 to 200 (nm), and the length (y-axis direction) of the optical waveguide is about several (mm).

One of the excellent features of the Si optical modulator is that a refractive index difference between Si as the core through which light propagates and SiO₂ of the cladding layer is large, so that a compact optical modulator can be configured. Since the refractive index difference is large, light can be confined small, and the bending radius of the optical waveguide can be made as very small as about 10 μm. Therefore, a light multiplexer/demultiplexer circuit portion in the Si optical modulator to be described next can be configured small.

### (Conventional Dual-Electrode Type Mach-Zehnder Type Optical Modulator)

FIG. 2 illustrates a Si optical modulator constituting a conventional dual-electrode type Mach-Zehnder type optical modulator. It is a planar structure in which a Si (SOI) substrate surface (x-y plane) seen through from above. The light input from the left optical modulator end is split into two optical waveguides 7a and 7b, modulated, and then coupled again, and to be optically output as modulated light from the right optical modulator end. The input light is phase-modulated by the modulation electrical signal (RF signal) applied to each of RF electrodes 15a and 15b while propagating through the two split optical waveguides 7a and 7b in the y-axis direction. The optical modulator has a coplanar waveguide (CPW) including two ground electrodes 16a and 17 sandwiching the RF electrode 15a for the optical waveguide 7a. Similarly, it has a CPW including two ground electrodes 16b and 17 sandwiching the RF electrode 15b for the optical waveguide 7b.

Since a configuration with two RF signal input portions in a single Mach-Zehnder (MZ) type optical modulator, it is called a dual-electrode structure. The MZ type optical modulator illustrated in FIG. 2 has a symmetrical structure with respect to a center line parallel to the y axis passing through the center of the ground electrode 17.

FIG. 3 illustrates a cross-sectional structure of III-III′ in FIG. 2, and illustrates only the phase modulation portion including the CPW corresponding to one optical waveguide 7a is subjected to a modulation. One phase modulation portion is an optical waveguide with a cross-sectional structure similar to that of the optical waveguide 200 illustrated in FIG. 1. The RF electrode 15a that is a radio frequency line to which one of the pair of differential modulation electrical signals (RF signals) is input, and the two ground electrodes 16a and 17 provided so as to sandwich the RF electrode 15a are included. One optical waveguide core 7a is provided between the RF electrode 15a and the ground electrode 16a, and a pn junction structure including the low-concentration p-type semiconductor layer 212 and the low-concentration n-type semiconductor layer 213 is formed in the optical waveguide 7a. The RF electrode 15a is in contact with the high-concentration n-type semiconductor layer 214 through a via 19b. In addition, the ground electrode 16a is in contact with the high-concentration p-type semiconductor layer 211 through a via 19a.

The ground electrode 17 is not in contact with any semiconductor layer, but forms a radio frequency transmission line (CPW) with a ground-signal-ground (GSG) structure for the RF electrode 15a together with the ground electrode 16a. With this transmission line structure, the characteristic impedance as the transmission line of the RF electrode can be adjusted to improve the transmission characteristics. In addition, since the signal line by the RF electrode 15a is surrounded by the two ground electrodes 16a and 17, it is possible to form an optical modulator with less signal leakage, and less crosstalk or propagation loss.

Note that FIG. 3 illustrates the phase modulation portion including the RF electrode 15a, which is a radio frequency line to which one of the modulation electrical signals (RF signals) with a differential configuration is input, but the phase modulation portion including the other RF electrode 15b also has a similar configuration to that of FIG. 3 except that the disposition order of the plurality of semiconductor regions in the x-axis direction is reversed with respect to the z axis as the symmetry axis.

The characteristic impedance as a radio frequency transmission line in the RF electrodes 15a and 15b of the Si optical modulator is significantly affected by the electrostatic capacitance of the pn junction portion of the optical waveguide cores 7a and 7b of the Si layer. However, since the electrostatic capacitance between the RF electrode and the ground electrode also affects, in the Si modulator with a dual-electrode structure, it is relatively easy to adjust the characteristic impedance by adjusting the electrostatic capacitance between the RF electrode 15a and the ground electrode 17. The characteristic impedance can be set to about 5002 in the single-end drive configuration and about 1002 in the differential drive configuration.

Here, the configuration example in which the RF electrode 15a is in contact with the high-concentration n-type semiconductor layer 214 and the ground electrode 16a is in contact with the high-concentration p-type semiconductor layer 211 has been described. On the other hand, the direction of the pn junction may be reversed, and the RF electrode 15a may be in contact with the high-concentration p-type semiconductor layer, and the ground electrode 16a may be in contact with the high-concentration n-type semiconductor layer. In this case, the pn junction portion can be reversely biased by applying a negative voltage to the ground electrode 16a as a bias voltage superimposed on the RF signal and given to the RF electrode 15a.

### (Conventional Vertical Pn Junction Optical Modulator)

FIG. 4 illustrates a cross-sectional structure of an optical waveguide of a Si optical modulator with a conventional vertical pn junction. FIG. 4 illustrates a cross-section (x-z plane) of the optical waveguide 200 formed on an SOI substrate, cut perpendicularly to a light traveling direction (y-axis). The light propagates in a direction perpendicular to the paper surface (y-axis direction). The method of configuring the optical waveguide of the Si optical modulator, the section of impurity doping, the configuration of the electrodes, the operation principle, and the like are similar to those of the conventional Si optical modulator illustrated in FIG. 1. A difference from the conventional structure is that a pn junction structure including the low-concentration p-type semiconductor layer 212 and the low-concentration n-type semiconductor layer 213 is disposed in a vertical direction (up and down in the drawing). That is, the pn junction plane is disposed in a horizontal direction (left and right in the drawing). Such a structure is called a vertical pn junction (see, for example, Non Patent Literature 1).

The width (x-axis direction) of the Si optical waveguide core 201 is 400 to 600 (nm), the height (z-axis direction) of the core portion is 150 to 300 (nm), the thickness of the slab region is 50 to 200 (nm), and the light propagating through the Si optical waveguide core 201 has a widthwise (x-axis direction) flat shape. Therefore, in the vertical pn junction optical waveguide with the pn junction plane in the horizontal direction, the overlapping part between the pn junction part where the carrier density changes by the application of the electric field and the light propagation mode becomes large. That is, in the vertical pn junction optical waveguide, as illustrated in FIG. 1, the pn junction structure is disposed in the horizontal direction (left and right in the drawing), and the overlapping part between the pn junction part and the light propagation mode becomes larger than that of the optical waveguide with the pn junction plane in the vertical direction. By changing the refractive index of the Si optical waveguide core 201 due to the change in the carrier density, the phase of light propagating through the core of the optical waveguide is modulated. Accordingly, the vertical pn junction can modulate light even at a low voltage, and an optical modulator with high modulation efficiency can be achieved.

Impurity doping into the Si optical modulator is performed by a method called ion implantation, which is commonly called implantation. In the ion implantation, since ions with a speed are implanted into a target substance, characteristics of the substance into which the ions are implanted can be changed. When boron (B) is implanted into Si, the characteristics of a p-type semiconductor are obtained, and when phosphorus (P) or arsenic (As) is implanted into Si, the characteristics of an n-type semiconductor are obtained. The concentration and depth at the time of implanting ions are controlled by a dose amount indicating the number of ions per unit area, an acceleration voltage which is energy at the time of accelerating ions, inclination of a wafer with respect to the direction of an ion beam, and the like.

When the vertical pn junction optical waveguide is manufactured, the thick Si layer 201 and the thin slab regions 202 are formed on an SOI substrate by etching, and then impurities such as phosphorus (P) or arsenic (As) is implanted by ion implantation in order to form the low-concentration n-type semiconductor layer 213. Next, in order to form the low-concentration p-type semiconductor layer 212, a means of implanting impurities such as boron (B) to the depth near the surface of the Si layer is generally used. In the Si optical waveguide core 201, ion implantation is performed such that an impurity for generating the n-type semiconductor layer and an impurity for forming the p-type semiconductor layer overlap with each other, and a dose amount of ions and an acceleration voltage are adjusted such that an upper portion of the optical waveguide part becomes the low-concentration p-type semiconductor layer.

Note that the p-type semiconductor layer and the n-type semiconductor layer with the structure illustrated in FIG. 4 may be reversed so that the upper portion of the Si optical waveguide core 201 is the low-concentration n-type semiconductor layer and the lower portion is the low-concentration p-type semiconductor. However, ion implantation into the Si layer is generally more difficult when implanting an impurity for the p-type semiconductor layer, and ion implantation to a deep portion from the substrate surface may damage the Si crystal. Therefore, it is general that the upper portion is a p-type semiconductor layer and the lower portion is an n-type semiconductor layer.

### (Conventional Interleaved Pn Junction Optical Modulator)

With reference to FIGS. 5 to 7, an optical waveguide of a conventional Si optical modulator with an interleaved pn junction will be described. FIG. 5 is a top diagram of a part of the optical waveguide 200 formed on the SOI substrate seen through from a direction perpendicular to the substrate surface (x-y plane). FIG. 6 is a plane (x-z plane) of the optical waveguide 200 formed on the SOI substrate, cut perpendicularly to a light traveling direction (y-axis), and is a cross-sectional diagram of VI-VI′ in FIG. 5. FIG. 7 is a cross-sectional diagram of VII-VII′ in FIG. 5, and light propagates in a direction perpendicular to the paper surface (y-axis direction). The method of configuring the optical waveguide of the Si optical modulator, the section of impurity doping, the configuration of the electrodes, the operation principle, and the like are similar to those of the conventional Si optical modulator illustrated in FIG. 1. A difference from the conventional structure is that the doping region occupying a major part of the Si optical waveguide core 201 has the low-concentration p-type semiconductor layer 212 and the low-concentration n-type semiconductor layer 213 disposed to be switched alternately along the light propagation direction (y-axis direction). Such a structure is called an interleaved pn junction (see, for example, Non Patent Literature 2).

As the interval at which the low-concentration p-type semiconductor layer 212 and the low-concentration n-type semiconductor layer 213 are switched is shortened, an overlapping part between the light propagating through the Si optical waveguide core 201 and the pn junction part becomes large. That is, the overlapping part between the pn junction part and the light propagation mode becomes larger than that of the optical waveguide in which the pn junction plane of the low-concentration p-type semiconductor layer 212 and the low-concentration n-type semiconductor layer 213 is disposed near the center of the Si optical waveguide core 201 as illustrated in FIG. 1. The effect of changing the refractive index of the Si optical waveguide core 201 can be more greatly received by the change in the carrier density. Accordingly, the interleaved pn junction can modulate light even at a low voltage, and an optical modulator with high modulation efficiency can be achieved.

Note that although the low-concentration p-type semiconductor layer 212 and the low-concentration n-type semiconductor layer 213 illustrated in FIG. 5 each extend to the sidewalls of the thick Si layer 201, the low-concentration p-type semiconductor layer 212 and the low-concentration n-type semiconductor layer 213 may be in contact with each other inside the Si optical waveguide core 201. In addition, the low-concentration p-type semiconductor layer 212 and the low-concentration n-type semiconductor layer 213 may each extend beyond the thick Si layer 201, and the low-concentration p-type semiconductor layer 212 and the low-concentration n-type semiconductor layer 213 may be in contact with each other in the slab regions 202a and 202b.

As described above, the ion implantation pattern in the Si optical waveguide core 201 includes the vertical pn junction and the interleaved pn junction in addition to the structure in which the pn junction structure of the low-concentration p-type semiconductor layer and the low-concentration n-type semiconductor layer is disposed in the horizontal direction (left and right in the drawing) and has a pn junction plane in the vertical direction. In these structures, phase change of light can be performed at a lower voltage, and highly efficient optical modulation can be achieved. By performing the optical modulation with high efficiency, it is possible to achieve low power consumption, high speed, high functionality, and the like of the optical communication system.

However, in the conventional ion implantation pattern, there are limits in power consumption, speed, and function of the Si optical modulator.

### CITATION LIST

### Patent Literature

Patent Literature 1: JP 6499804 B2

### Non Patent Literature

Non Patent Literature 1: Michael R. Watts, William A. Zortman, Student Member, IEEE, Douglas C. Trotter, Ralph W. Young, and Anthony L. Lentine, “Low-voltage, compact, depletion-mode, silicon Mach-Zehnder modulator”, IEEE JSTQE, vol. 16, no. 1, pp. 159-164, 2010.
Non Patent Literature 2: Z. Y. Li, D.-X. Xu, R. Mckinnon, S. Janz, J. H. Schmid, J. Lapointe, P. Cheben, and J. Z. Yu, “Low Driving-Voltage Optical Modulator Based on Carrier Depletion in Silicon with Periodically Interleaved P-N Junctions”, 2008 5th IEEE International Conference on Group IV Photonics, 17-19 Sep. 2008, WA5, pp. 13-15, 2008.

### SUMMARY OF INVENTION

An object of the present invention is to provide an optical modulator capable of enhancing optical modulation efficiency by with a structure in which an ion implantation pattern can be controlled with a wider range of options.

In order to achieve such an object, an embodiment of the present invention is an optical modulator including a semiconductor layer with a pn junction in an optical waveguide core, the optical modulator modulating an optical signal by applying a bias voltage to the semiconductor layer together with a radio frequency (RF) signal, the optical modulator including: a low-concentration p-type semiconductor layer and a low-concentration n-type semiconductor layer that form the pn junction; and a medium-concentration p-type semiconductor layer that is added to the low-concentration p-type semiconductor layer or a medium-concentration n-type semiconductor layer that is added to the low-concentration n-type semiconductor layer, in which the optical waveguide core is configured with three layers of the low-concentration p-type semiconductor layer, the medium-concentration p-type semiconductor layer, and the low-concentration n-type semiconductor layer, or configured with three layers of the low-concentration p-type semiconductor layer, the medium-concentration n-type semiconductor layer, and the low-concentration n-type semiconductor layer.

### BRIEF DESCRIPTION OF DRAWINGS

FIG. 1 is a diagram illustrating a cross-sectional structure of an optical waveguide as the basis of a Si optical modulator of a conventional technique.

FIG. 2 is a plan diagram illustrating a Si optical modulator constituting a conventional dual-electrode type Mach-Zehnder type optical modulator.

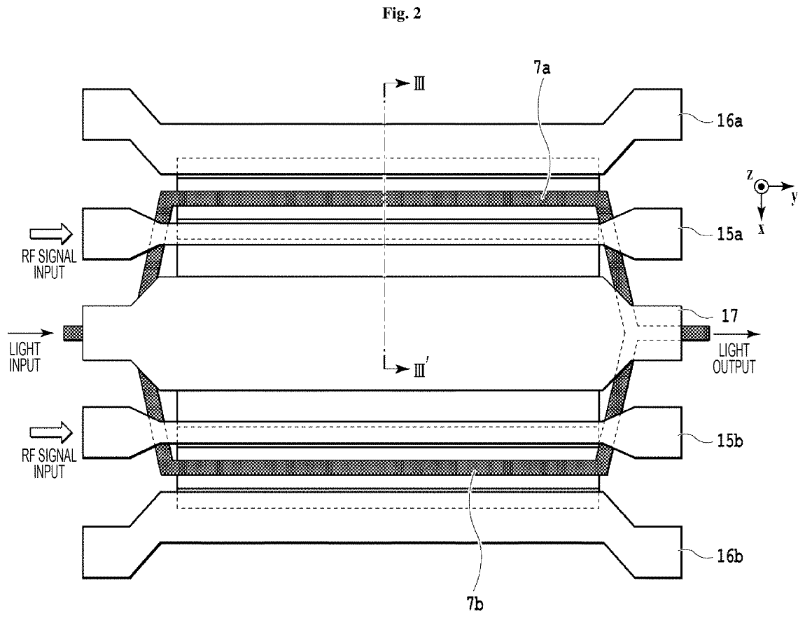

FIG. 3 is a cross-sectional diagram illustrating a Si optical modulator constituting a conventional dual-electrode type Mach-Zehnder type optical modulator.

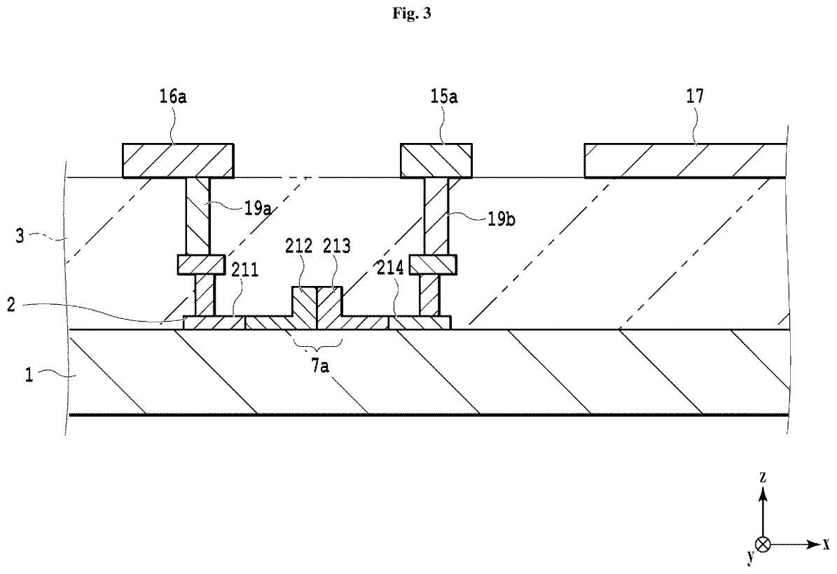

FIG. 4 is a diagram illustrating a cross-sectional structure of an optical waveguide of a conventional Si optical modulator with a vertical pn junction.

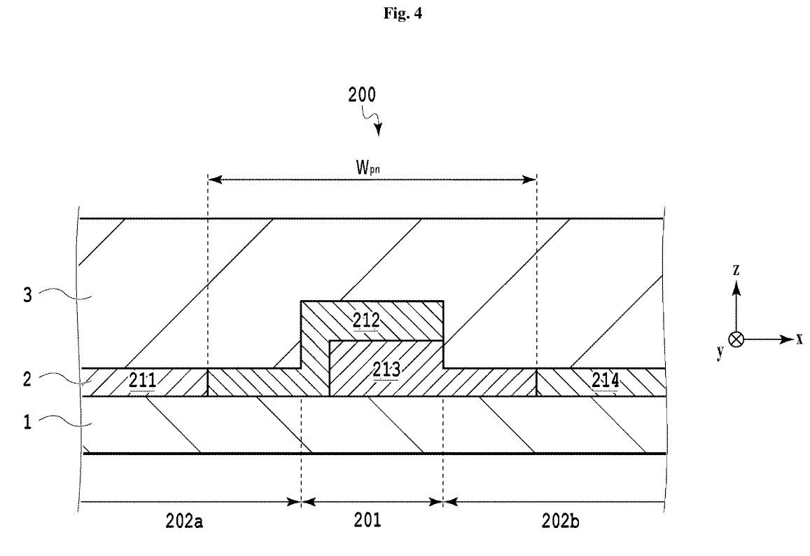

FIG. 5 is a plan diagram illustrating an optical waveguide of a conventional Si optical modulator with an interleaved pn junction.

FIG. 6 is a cross-sectional diagram illustrating an optical waveguide of a conventional Si optical modulator with an interleaved pn junction.

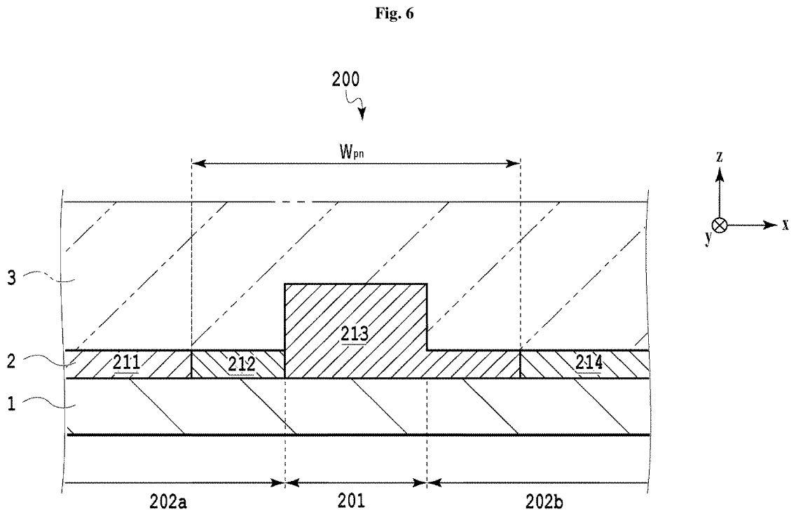

FIG. 7 is a cross-sectional diagram illustrating an optical waveguide of a conventional Si optical modulator with an interleaved pn junction.

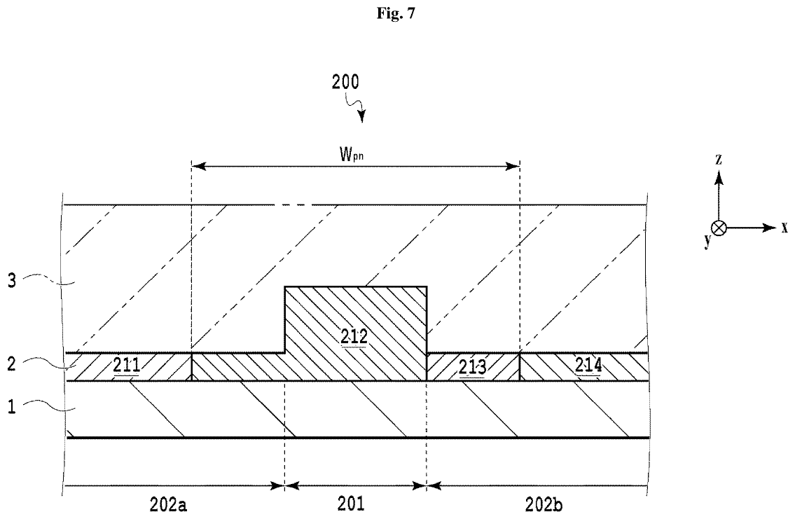

FIG. 8 is a diagram illustrating a cross-sectional structure of an optical waveguide of a Si optical modulator according to Example 1 of the present invention.

FIG. 9 is a plan diagram illustrating an optical waveguide of a Si optical modulator according to Example 2 of the present invention.

FIG. 10 is a diagram illustrating a cross-sectional structure of an optical waveguide of a Si optical modulator of Example 2.

FIG. 11 is a diagram illustrating a cross-sectional structure of an optical waveguide of a Si optical modulator of Example 2.

### DESCRIPTION OF EMBODIMENTS

An embodiment of the present invention will be described in detail below with reference to the drawings.

### Example 1

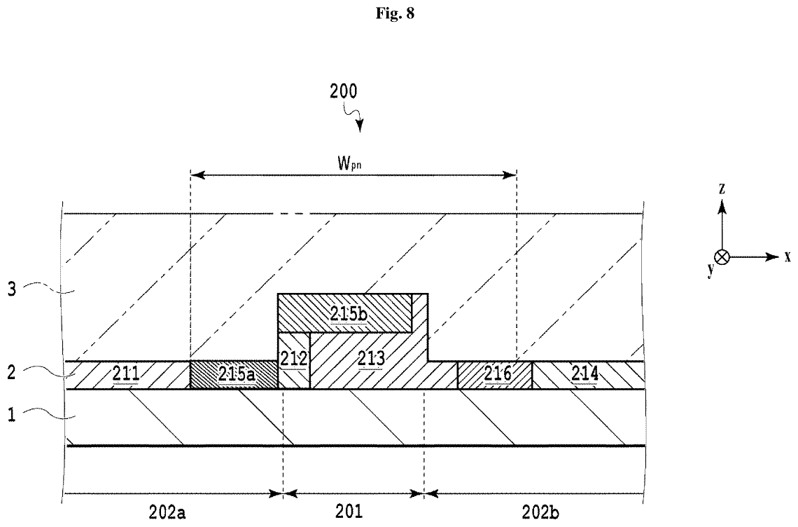

FIG. 8 illustrates a cross-sectional structure of an optical waveguide of a Si optical modulator according to Example 1 of the present invention. FIG. 8 illustrates a cross-section (x-z plane) of the optical waveguide 200 formed on an SOI substrate, cut perpendicularly to a light traveling direction (y-axis). The light propagates in a direction perpendicular to the paper surface (y-axis direction). The Si optical modulator of Example 1 is a Si optical modulator with a vertical pn junction, and the method of configuring the optical waveguide of the Si optical modulator, the section of impurity doping, the configuration of the electrodes, the operation principle, and the like are similar to those of the conventional Si optical modulator. The optical waveguide core 201 is a rib waveguide including a Si layer sandwiched between SiO₂ cladding layers on a Si substrate, and is a thick Si layer at the center. A difference from the conventional structure is that medium-concentration p-type semiconductor layers 215a and 215b and a medium-concentration n-type semiconductor layer 216 are added.

The medium-concentration p-type semiconductor layer 215a is ion-implanted in a manner overlapping with the ion implantation pattern for forming the low-concentration p-type semiconductor layer 211 in the slab region 202a thinner than the Si optical waveguide core 201. Similarly, the medium-concentration n-type semiconductor layer 216 is ion-implanted in a manner overlapping with the ion implantation pattern for forming the low-concentration n-type semiconductor layer 213 in the slab region 202b thinner than the Si optical waveguide core 201. The medium-concentration p-type semiconductor layer 215a and the medium-concentration n-type semiconductor layer 216 are also used to lower the electrical resistivity of the slab regions 202a and 202b. Reducing the electrical resistivity of the slab regions 202 suppresses the loss of a radio frequency electrical signal applied to the optical modulator, and is effective for high-speed operation of the optical modulator.

The medium-concentration p-type semiconductor layer 215a and the medium-concentration n-type semiconductor layer 216 are intended to implant ions into the thin slab regions 202a and 202b, and the acceleration voltage for the ion implantation is set to be smaller than that in a case where ions are implanted into the low-concentration p-type semiconductor layer 212 and the low-concentration n-type semiconductor layer 213. As the condition for implanting ions into the low-concentration p-type semiconductor layer 212 and the low-concentration n-type semiconductor layer 213, in a case where ion implantation is performed a plurality of times in a shallow region close to the substrate surface and a deep region deep from the substrate surface, the ion implantation is performed at an acceleration voltage comparable with the acceleration voltage at the time of ion implantation into the shallow region.

Here, there are three types of classification: high concentration, medium concentration, and low concentration, but the ion implantation into the medium-concentration semiconductor layer is performed by overlapping with the pattern of the ion implantation into the low concentration. Therefore, as the condition for ion implantation, a dose amount indicating the number of ions per unit area may be smaller than the condition for ion implantation into the low-concentration semiconductor layer. This is because the interval between the high-concentration p-type semiconductor layer 211 and the high-concentration n-type semiconductor layer 214 is merely about several microns, and is small with respect to the manufacture accuracy of an ion implantation mask, and thus, the ion implantation into high concentration and medium concentration is generally performed by overlapping with the pattern for lower concentration.

In the Si optical modulator of Example 1, the medium-concentration p-type semiconductor layer 215b expands in a region close to the substrate surface of the Si optical waveguide core 201 in addition to the slab region 202a. A mask for forming the medium-concentration p-type semiconductor layer is expanded to a portion overlapping with the Si optical waveguide core 201, and ion implantation is performed in a shallow region close to the substrate surface. In this manner, the Si optical waveguide core 201 is configured with three layers including the medium-concentration p-type semiconductor layer 215b in addition to the low-concentration p-type semiconductor layer 212 and the low-concentration n-type semiconductor layer 213.

In the Si optical waveguide core 201, a pn junction structure configured by the low-concentration p-type semiconductor layer 212 and the low-concentration n-type semiconductor layer 213 is disposed in the horizontal direction (left and right in the drawing), and a pn junction structure configured by the medium-concentration p-type semiconductor layer 215b and the low-concentration n-type semiconductor layer 213 is disposed in the vertical direction (up and down in the drawing). A modulation electrical signal and a bias voltage are applied through electrodes in contact with the high-concentration p-type semiconductor layer 211 and the high-concentration n-type semiconductor layer 214 at both ends of the Si layer 2. The carrier density of the Si optical waveguide core 201 is changed by the modulation electrical signal and the reverse bias voltage. With changing the carrier density to cause a change in the refractive index of the Si optical waveguide core 201 due to the carrier plasma effect, the phase of light propagating through the core of the optical waveguide can be modulated.

The width (x-axis direction) of the Si optical waveguide core 201 is 400 to 600 (nm), the height (z-axis direction) of the core portion is 150 to 300 (nm), the thickness of the slab region is 50 to 200 (nm), and the light propagating through the Si optical waveguide core 201 has a widthwise (x-axis direction) flat shape. Therefore, by the pn junction plane in the horizontal direction formed in the Si optical waveguide core 201, the overlapping part between the pn junction part where the carrier density changes by the application of the electric field and the light propagation mode becomes large. With changing the carrier density to cause a change in the refractive index of the Si optical waveguide core 201, the phase of light propagating through the core of the optical waveguide is modulated. Accordingly, the Si optical modulator of Example 1 can modulate light even at a low voltage, and an optical modulator with high modulation efficiency can be achieved.

In addition, in order to dispose the pn junction part in the central portion of the Si optical waveguide core 201 where the distribution density of propagating light is high, that is, in order to make the pn junction plane large in the horizontal direction, the boundary between the low-concentration p-type semiconductor layer 212 and the low-concentration n-type semiconductor layer 213 is close in the direction of the slab region 202a. With such a structure, an optical modulator with higher modulation efficiency can be achieved.

The conventional vertical pn junction includes the two layers: the low-concentration p-type semiconductor layer 212 and the low-concentration n-type semiconductor layer 213. Therefore, the ion-implanted semiconductor layer is not linked to a shallow region close to the substrate surface at the boundaries between the optical waveguide core 201 and the slab regions 202, and electrical disconnection or an increase in resistance has occurred. In order to prevent this, it was necessary to set the pn junction plane in a deep region further from the substrate surface to link the ion-implanted semiconductor layer in a shallow region close to the substrate surface.

In the Si optical modulator of Example 1, since the low-concentration p-type semiconductor layer 212 is provided between the medium-concentration p-type semiconductor layer 215b formed in a shallow region of the optical waveguide core 201 and the medium-concentration p-type semiconductor layer 215a formed in the slab region 202, there is no concern that the medium-concentration p-type semiconductor layers 215a and 215b are disconnected, and a pn junction plane can be set at a free position.

In FIG. 8, the medium-concentration p-type semiconductor layer 215b is ion-implanted into a shallow region close to the substrate surface of the optical waveguide core 201, but the medium-concentration n-type semiconductor layer 216 may have a structure of being ion-implanted into a shallow region close to the substrate surface of the optical waveguide core 201. In this case, the pn junction part is disposed in the central portion of the optical waveguide core 201 where the distribution density of propagating light is high. Therefore, the boundary between the low-concentration p-type semiconductor layer 212 and the low-concentration n-type semiconductor layer 213 is not located at the center of the optical waveguide core 201, but is favorably close in the direction of the slab region 202b. With this structure, an optical modulator with higher modulation efficiency can be achieved.

### Example 2

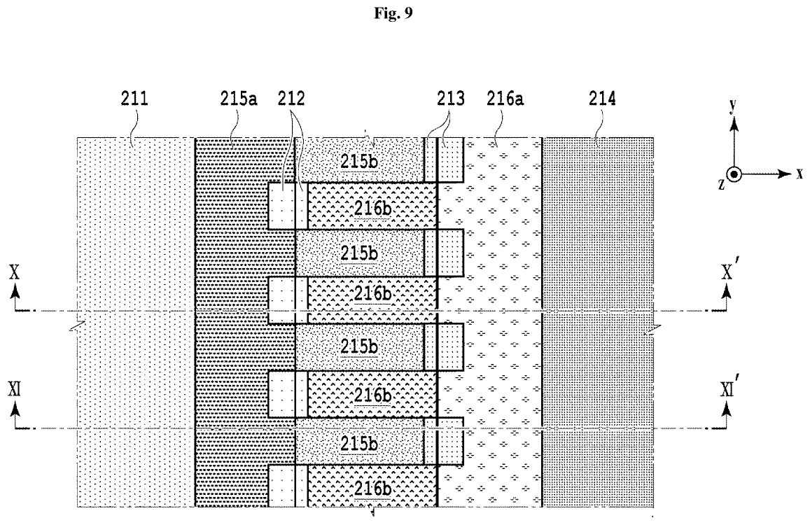

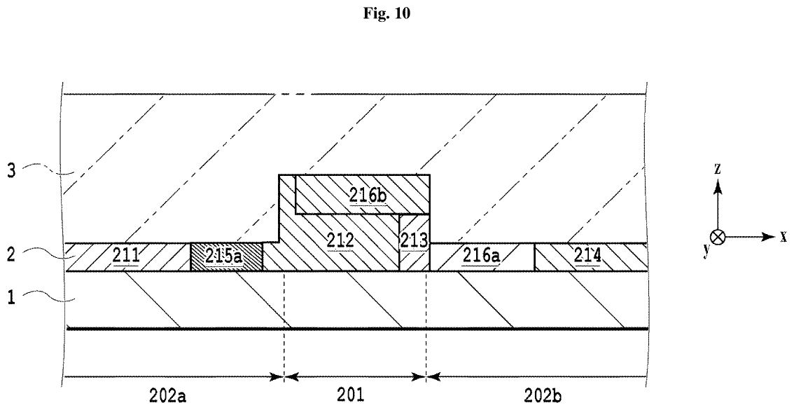

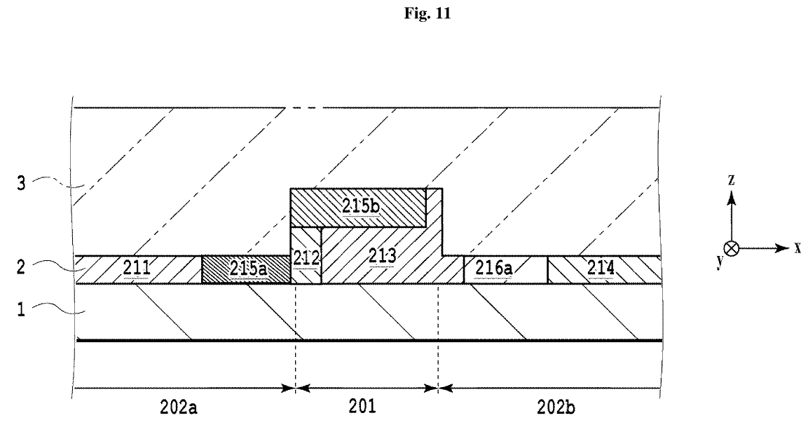

FIG. 9 illustrates an optical waveguide of a Si optical modulator according to Example 2 of the present invention. FIG. 9 is a top diagram of a part of the optical waveguide 200 formed on the SOI substrate seen through from a direction perpendicular to the substrate surface (x-y plane). FIG. 10 is a plane (x-z plane) of the optical waveguide 200 formed on the SOI substrate, cut perpendicularly to a light traveling direction (y-axis), and is a cross-sectional diagram of X-X′ in FIG. 9. FIG. 11 is a cross-sectional diagram of XI-XI′ in FIG. 9, and light propagates in a direction perpendicular to the paper surface (y-axis direction).

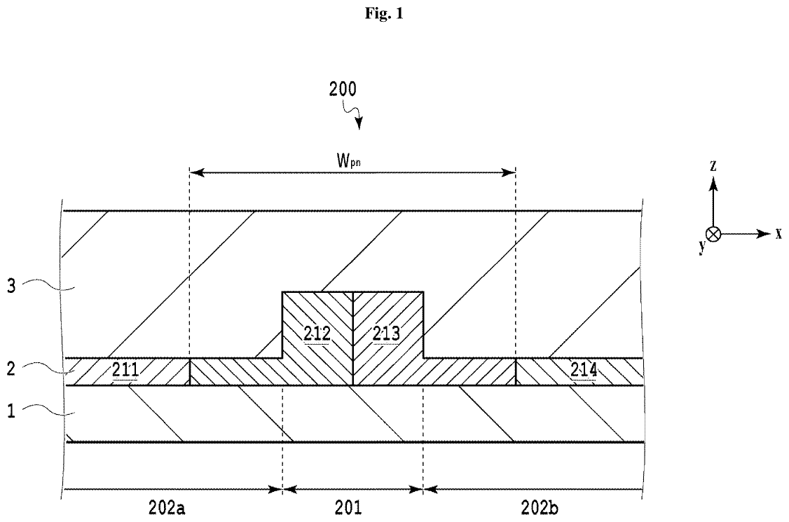

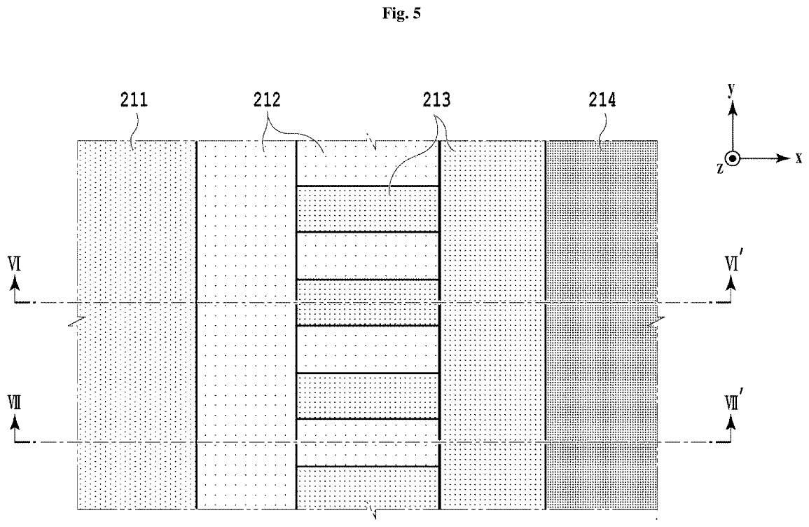

The Si optical modulator of Example 2 is a Si optical modulator with an interleaved pn junction, and the method of configuring the optical waveguide of the Si optical modulator, the section of impurity doping, the configuration of the electrodes, the operation principle, and the like are similar to those of the conventional Si optical modulator illustrated in FIGS. 1 and 5. A difference from the conventional structure is that medium-concentration p-type semiconductor layers 215a and 215b, and medium-concentration n-type semiconductor layers 216a and 216b are added. The aspect of ion implantation for forming the medium-concentration semiconductor layer is similar to that of the Si optical modulator of Example 1.

A difference from the Si optical modulator of Example 1 is that the doping region distributed in the region close to the surface of the Si optical waveguide core 201 has the medium-concentration p-type semiconductor layer 215b and the medium-concentration n-type semiconductor layer 216b alternately switched along the light propagation direction (y-axis direction). In addition, the boundary between the low-concentration p-type semiconductor layer 212 and the low-concentration n-type semiconductor layer 213 is not located at the center of the optical waveguide core 201, and the case of being close to the slab region 202a side and the case of being close to the slab region 202b side are disposed to be alternately switched. As described above, the interleaved pn junction is achieved by the vertical pn junction.

In the Si optical modulator of Example 2, the waveguide in which the medium-concentration n-type semiconductor layers 216a and 216b expand in the region close to the substrate surface of the optical waveguide core 201 in addition to the slab region 202b and the waveguide in which the medium-concentration p-type semiconductor layers 215a and 215b expand in the region close to the substrate surface of the optical waveguide core 201 in addition to the slab region 202a are alternately switched. The formation can be performed by separating the part where the mask for forming the medium-concentration n-type semiconductor layer is expanded to a part overlapping the optical waveguide core 201 and ion implantation is performed into a shallow region close to the substrate surface and the part where the mask for forming the medium-concentration p-type semiconductor layer is expanded to a part overlapping the optical waveguide core 201 and ion implantation is performed into a shallow region close to the substrate surface. As described above, the optical waveguide core 201 of the Si optical modulator of Example 2 is configured with four layers including the medium-concentration p-type semiconductor layer 215b and the medium-concentration n-type semiconductor layer 216b in addition to the low-concentration p-type semiconductor layer 212 and the low-concentration n-type semiconductor layer 213.

In the optical waveguide core 201 of the Si optical modulator, a pn junction structure is configured by: the medium-concentration p-type semiconductor layer 215b and the low-concentration p-type semiconductor layer 212; and the medium-concentration n-type semiconductor layer 216b and the low-concentration n-type semiconductor layer 213. A modulation electrical signal and a bias voltage are applied from both left and right ends of the Si layer 2 through electrodes, which are not illustrated. The carrier density of the optical waveguide core 201 is changed ty the modulation electrical signal and the reverse bias voltage. With changing the carrier density to cause a change in the refractive index of the core 201 of the optical waveguide due to the carrier plasma effect, the phase of light propagating through the core of the optical waveguide can be modulated.

The width (x-axis direction) of the Si optical waveguide core 201 is 400 to 600 (nm), the height (z-axis direction) of the core portion is 150 to 300 (nm), the thickness of the slab region is 50 to 200 (nm), and the light propagating through the Si optical waveguide core 201 has a widthwise (x-axis direction) flat shape. Therefore, by the pn junction plane in the horizontal direction formed in the Si optical waveguide core 201, the overlapping part between the pn junction part where the carrier density changes by the application of the electric field and the light propagation mode becomes large. With changing the carrier density to cause a change in the refractive index of the Si optical waveguide core 201, the phase of light propagating through the core of the optical waveguide is modulated. Accordingly, the Si optical modulator of Example 2 can also modulate light even at a low voltage, and an optical modulator with high modulation efficiency can be achieved.

Further, in the Si optical modulator of Example 2, a boundary part between the medium-concentration p-type semiconductor layer 215b and the medium-concentration n-type semiconductor layer 216b formed in a shallow region of the optical waveguide core 201 is also a pn junction portion. Therefore, the overlapping part between the light propagating through the optical waveguide core 201 and the pn junction part can be made larger than that of the conventional optical waveguide of the vertical pn junction waveguide structure and the optical waveguide of the Si optical modulator of Example 1. Accordingly, the effect of changing the refractive index of the core 201 of the optical waveguide can be more greatly received by the change in the carrier density. With the Si optical modulator of Example 2, as described above, the light can be modulated even at a lower voltage along the light propagation direction (y-axis direction) as compared with the conventional optical modulator with a vertical pn junction or interleaved pn junction, and an optical modulator with high modulation efficiency can be achieved.

### INDUSTRIAL APPLICABILITY

In general, the present invention can be applied to an optical communication system. In particular, it can be applied to an optical modulator in an optical transmitter of an optical communication system.

1. An optical modulator comprising:
a semiconductor layer with a pn junction in an optical waveguide core, an optical signal being modulated by applying a bias voltage to the semiconductor layer together with a radio frequency (RF) signal;
a low-concentration p-type semiconductor layer and a low-concentration n-type semiconductor layer configured to form the pn junction; and
a medium-concentration p-type semiconductor layer that is added to the low-concentration p-type semiconductor layer or a medium-concentration n-type semiconductor layer that is added to the low-concentration n-type semiconductor layer, wherein
the optical waveguide core is configured with three layers of the low-concentration p-type semiconductor layer, the medium-concentration p-type semiconductor layer, and the low-concentration n-type semiconductor layer, or configured with three layers of the low-concentration p-type semiconductor layer, the medium-concentration n-type semiconductor layer, and the low-concentration n-type semiconductor layer.

2. An optical modulator comprising:
a semiconductor layer with a pn junction in an optical waveguide core, an optical signal being modulated by applying a bias voltage to the semiconductor layer together with a radio frequency (RF) signal;
a low-concentration p-type semiconductor layer and a low-concentration n-type semiconductor layer configured to form the pn junction; and
a medium-concentration p-type semiconductor layer that is added to the low-concentration p-type semiconductor layer or a medium-concentration n-type semiconductor layer that is added to the low-concentration n-type semiconductor layer, wherein
the optical waveguide core has a structure in which a first set of three layers and a second set of three layers are disposed to be alternately switched along a light propagation direction,
wherein the first set of three layers is configured with the low-concentration p-type semiconductor layer, the medium-concentration p-type semiconductor layer, and the low-concentration n-type semiconductor layer, and
wherein the second set of three layers is configured with the low-concentration p-type semiconductor layer, the medium-concentration n-type semiconductor layer, and the low-concentration n-type semiconductor layer.

3. The optical modulator according to claim 1, wherein the optical waveguide core is a rib waveguide including a Si layer sandwiched between SiO₂ cladding layers on a Si substrate.

4. The optical modulator according to claim 2, wherein the optical waveguide core is a rib waveguide configured with a Si layer sandwiched between SiO₂ cladding layers on a Si substrate.
